(19) United States
(12) Patent Application Publication
(10) Pub. No.: US 2007/0072456 A1
(43) Pub. Date: Mar. 29, 2007

(54) Device and method for interconnection of box-profile elements, and assembly

(76) Inventor: Michiel Zweers, Gouda (NL)

Correspondence Address: THE WEBB LAW FIRM, P.C., 700 KOPPERS BUILDING, 436 SEVENTH AVENUE, PITTSBURGH, PA, 15219, US

(21) Appl. No.: 10/574,250

(22) PCT Filed: Oct. 5, 2004
(86) PCT No.: PCT/NL04/00698

§ 371 Date: Nov. 30, 2006

(30) Foreign Application Priority Data
Oct. 6, 2003 (NL) 1024455

(51) Int. Cl. H01R 13/648

(52) U.S. Cl. 439/108

(57) ABSTRACT

The invention relates to a device for interconnection of box-profile elements, comprising: an at least substantially rigid first connection element provided with multiple first receptors for parts of multiple box-profile elements, and at least substantially rigid second connection element adapted for cooperation with the first connection element, said second connection element being provided with multiple second receptors corresponding to the first receptors, for parts of multiple box-profile elements, and securing means coupled with the first connection element and the second connection element to secure the mutual connection of the first connection element and the second connection element. The invention also relates to the assembly of multiple box-profile elements and such a device. The invention further relates to a method for interconnection of box-profile elements.

The invention relates to a device for interconnection of box-profile elements, comprising: an at least substantially rigid first connection element provided with multiple first receptors for parts of multiple box-profile elements, an at least substantially rigid second connection element adapted for cooperation with the first connection element, said second connection element being provided with multiple second receptors corresponding to the first receptors, for parts of multiple box-profile elements, and securing means coupled with the first connection element and the second connection element to secure the mutual connection of the first connection element and the second connection element. The invention also relates to the assembly of multiple box-profile elements and such a device. The invention further relates to a method for interconnection of box-profile elements.

The device mentioned in the preamble is already known from the prior art. The German patent publication DE 2903119 discloses a joint connection for releasably mutual coupling of pipes that cross one another. The joint connection that is currently in use comprises a lower connection element with multiple receptors for pipe sections, and an upper connection element adapted for cooperation with said lower connection element, said upper connection element being provided with multiple receptors for pipe sections. The joint also comprises a yoke plate positioned on the upper connection element that is arranged to work together with projecting claws on the lower connection element when the pipes are clamped into the joint connection. To this end, the yoke plate is provided with a central stud that can displaced relatively to the yoke towards the upper connection element in order to strengthen the clamping of the pipes by the joint connection. The stud is retained by a lock nut. The known device has several drawbacks. One disadvantage of the device is that its construction is relatively complex. Furthermore, the achievable clamping action of the device on the pipes is relatively weak due to the relatively poor transfer of force in the device. Specifically, the force transferred through the yoke plate via the stud to the upper connection element is commonly too small to achieve a solid clamping action of the device on the pipes, particularly if a considerable bending moment is applied to the pipes. For this reason, the known device is only appropriate for a very limited number of applications, and in particular in a vertical orientation.

It is an object of the invention to provide a device of relatively simple construction for interconnection of box-profile elements in a relatively solid manner.

The invention provides to that end a device according to the preamble, characterised in that the securing means comprises at least one locking pin that is, at least partially enclosed by both connection elements, said locking pin being adapted for engagement on a side of the first connection element opposite to the second connection element and on a side of the second connection element opposite to the first connection element. The locking pin is adapted to cause both connection elements to affect a prestressed grip on one another, and therefore functions in particular as a prestressed bolt. Because the locking pin is adapted to exert a relatively high prestress force on the connection elements, the dynamic forces exerted on the box-profile elements can be absorbed, which results in a relatively firm clamping action. In addition, the construction of the device is relatively simple. Only three elements are required to achieve a relatively durable and solid clamping of the box-profile elements in the device. The device can additionally be applied in a wide range of circumstances and situations, in any desired orientation. One can imagine that a device according to the invention could be used for the construction of permanent or temporary houses or commercial buildings. The locking pin is preferably located at a central position relative to both connection elements in order to optimise the transfer of force to both connection elements. Moreover, the locking pin is positioned in the centre line of both connection elements, which means that the locking pin, in fact, extends through the centre of each connection element. It is, however, also conceivable that in certain situations multiple locking pins are applied in a single device for securing both connection elements. In this way, for example, a locking pin could pass through each corner of a connection element to arrange the transfer of forces within the joint in another way. Since the connection elements are generally designed with right angles, it can be advantageous to apply four locking pins for the mutual coupling of both the connection elements, with the locking pins positioned at, or at least close to, the corners of the connection elements.

In a preferred embodiment, the effective length of the locking pin is adjustable. In this manner, it is possible to regulate the prestressing forces exerted by the connection elements on the box-profile elements. It is also imaginable to increase the length of the locking pin such that the connection elements can be positioned at a, yet limited, distance from one another. It should be clear that, in this arrangement, the box-profile elements are no longer clamped by the device and can therefore be removed from the device with relatively little effort. This arrangement provides a device that is suitable for releasably coupling of multiple box-profile elements. Furthermore, by establishing a certain amount of play between the two coupling elements, a pre-assembly mode can be achieved, which allows the box-profile elements to be attached to the device in a relatively instable state. After this pre-assembly, the effective length of the locking pin can be shortened, as a result of which a relatively solid, stable and durable clamping of the box-profile elements in the device can be realised. The regulation of the effective length of the locking pin is, for example, achievable in combination with a lock nut. Preferably, the locking pin is provided with at least one eccentrically rotatable element engaging a connection element. Through rotation of the eccentrically rotatable element, the effective length of the locking pin can be regulated as well. An exceptional advantage of such a locking pin is that the prestress force is already determined in advance, ensuring a particular degree of certainty, and therefore safety during application of the locking pin. In a specific, preferred embodiment, the eccentric, rotatable element is provided with a handle. In this manner, rotation of the eccentrically rotatable element is facilitated for a user. The handle is preferably releasably coupled with the eccentrically rotatable element, allowing the handle to be removed after rotation of the eccentric, rotatable element (and after the associated application of prestress on the connection elements) in order to minimise the amount of space occupied by the device. This preferred embodiment of the device is particularly suitable for application in the construction of modular houses and (other types of) detachable structures.

In another preferred embodiment, the locking pin is provided with at least one cam designed to retain a connection element. The cam can be solidly attached to the locking pin and therefore does not serve to adjust the length of the locking pin. It is also possible that the cam is executed as a nut, which can be rotated coaxially around the locking pin. This allows regulation of the effective length of the locking pin. Generally, one end of the locking pin will be provided with a permanently attached cam, and an opposite end of the locking pin will be provided with an element for the regulation of the effective length of the locking pin.

In yet another preferred embodiment, the locking pin is releasably coupled with at least one of the connection elements. It is, therefore, possible to completely detach the first connection element from the second connection element, which can further facilitate the (pre-)attachment of the box-profile elements to the device. Furthermore, this design allows the separate connection elements to be replaced and/or maintained in a relatively simple manner. The locking pin can be removed from the connection element by translation or rotation of the locking pin in relation to the particular connection element, after which the locking pin can be removed through a slot in the connection element.

Preferably, at least some of the first receptors and second receptors are profiled at least partially. This type of profiling usually increases the strength of the clamping action on the box-profile elements in the device.

In a preferred embodiment, at least one connection element is provided with coupling means for attachment of the device to an external object. The type, dimensions and geometry of the coupling means are in particular dependant on the external object to which the device must be attached. The external objects can, of course, be widely diverse in nature, and may include, for example, a wall, a floor, a textile product, et cetera. In a specific, preferred embodiment, the attachment elements can be releasably connected to their associated connection elements. The releasably connection further increases the flexibility and potential applicability of a joint according to the invention.

The invention also relates to an assembly of such a device and multiple box-profile elements, wherein the box-profile elements are clamped into the receptors of the device. Preferably, the box-profile elements are, at least primarily, positioned in a single plane. The prestress exerted upon the box-profile elements is sufficiently large that the device can be oriented in any position. In another preferred embodiment, the box-profile elements, or at least some of them, are not in the same plane. In that case, the assembly can, for example, be executed in a dome-shaped arrangement.

The invention further relates to a method for the interconnection of box-profile elements by using such a device, comprising the steps: a) positioning parts of multiple box-profile elements in the first and corresponding second receptors, and b) clamping the box-profile elements into the device by shortening the effective length of the locking pin to achieve a prestress between the first connection element and the second connection element. Step a) can be considered to be a (pre-)assembly step that occurs before the actual interconnection of the box-profile elements, which is effected by the clamping action according to step b). Shortening of the effective length of the locking pin can be achieved by the manners previously described. Disassembly of the box-profile elements can be achieved in a reciprocal fashion, with as first step an increase in the effective length of the locking pin, followed by the removal of the box-profile elements from the device.

The invention will be explained on the basis of the non-limiting embodiments shown in the following figures, wherein:

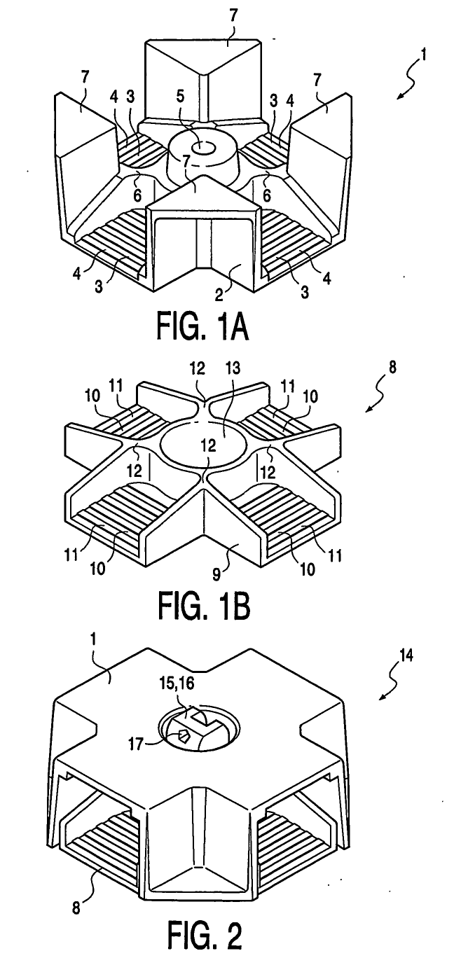

FIG. 1a shows a perspective view of a shoe used in a joint according to the invention,

FIG. 1b shows a perspective view of a clamp used in a joint according to the invention,

FIG. 2 shows a perspective view of a preferred embodiment in accordance with the invention,

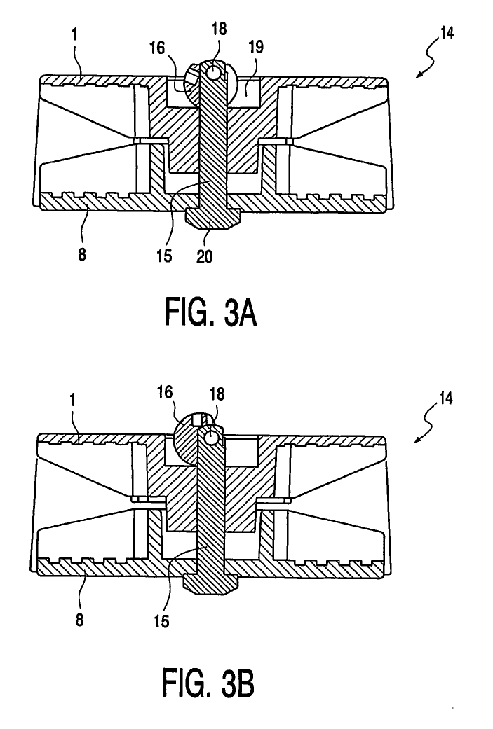

FIG. 3a shows the cross-section of a joint, corresponding with FIG. 2, in the closed position,

FIG. 3b shows the cross-section of a joint, corresponding with FIG. 2, in the opened position,

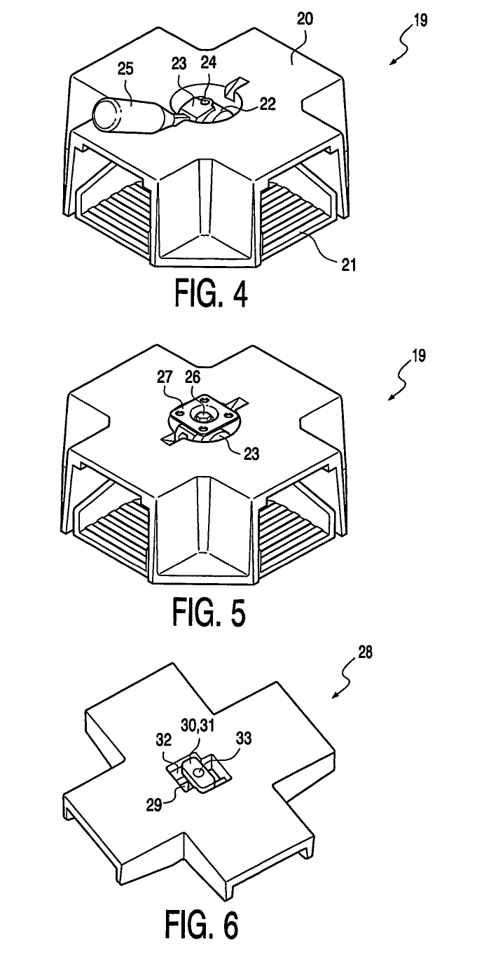

FIG. 4 shows a perspective view of another preferred embodiment of a joint in accordance with the invention in an operational arrangement,

FIG. 5 shows a perspective view of a joint, corresponding with FIG. 4, which is ready for use, and

FIG. 6 shows a perspective view of another clamp used in a device in accordance with the invention.

FIG. 1a shows a perspective view of a shoe 1 used in a joint according to the invention. A compatible joint is also shown in FIG. 2. The shoe 1 is provided with a basic structure 2 with four receptors 3 for the ends of beam-shaped elements (not shown). Each of the receptors 3 is provided with a profiled surface 4. The profiled surface 4 can be integrated into the basic structure or can be formed as a separate layer of material, preferably made of an elastomer. The beam-shaped elements can be provided with a counter-profile adapted for cooperation with the profile 4 of the basic structure 2. Preferably, both the profile 4 and the counter-profile are designed in such a way that the surface-area contact between the profiles is maximised in order to optimise the clamping action of the basic structure 2 on the beam-shaped elements. Furthermore, the geometry of the profile elements can influence the clamping action of the basic structure 2. A relatively large tooth angle, as well as the application of relatively sharp, non-bevelled teeth will also contribute to an improved clamping action on the beam-shaped elements in the basic structure 2. The basic structure 2 is provided with a central passage 5 for a central locking pin (not shown). The receptors 3 are interconnected by means of (diagonal) reinforcement ribs 6 and four corner gussets 7. The shoe 1 can be constructed of various materials, such as metal and/or plastic, however the preference is for an essentially rigid construction.

FIG. 1b shows a perspective view of a clamp 8 used in a joint according to the invention. The clamp 8 is adapted for cooperation with the shoe 1 shown in FIG. 1. The clamp 8 also comprises a basic structure 9 is provided with four receptors 10 for the ends of beam-shaped elements. To this end, the receptors 10 each include a profiled surface 11 and are interconnected with reinforcement ribs 12. The basic structure additionally is provided with a central passage 13 for a central locking pin (not shown).

FIG. 2 shows a perspective view of a preferred embodiment of a joint 14 according to the invention. The joint 14 is provided with a shoe 1 as shown in FIG. 1a, a clamp 8 that works together with shoe 1 as shown in FIG. 1b, and a locking pin 15 that extends through the openings 5, 13 (not shown) in the shoe 1 and the clamp 8. Only the end of the locking pin 15 is shown in FIG. 2. The end is provided with an eccentric, rotatable head 16, with the rotation axis of the head 16 substantially oriented at a right angle to the locking pin 15. The head 16 is provided with a socket 17 for the socket head portion of a handle (not shown). In the configuration shown, the head 16 is oriented so that the head 16 exerts a prestress on the shoe 1 and that the opposite end of the locking pin 15 exerts an equal and opposite prestress on the clamp 8, resulting in sufficient pre-stress between the shoe 1 and the clamp 8 to effect a solid clamping of the elements positioned in the receptors 3, 10. It should be clear that the effectiveness of the clamping action is also dependent on the dimensions of the beam-shaped elements. Preferably, these elements and the receptors of the shoe 1 and the clamp 8 fit together well. This solid clamping can be reduced through the rotation of the head 16 of the locking pin 15, which increases the effective length of the locking pin 15, thereby (considerably) reducing the applied prestress.

FIG. 3a shows the cross-section of the joint 14 corresponding with FIG. 2 in the closed position. This closed position is also shown in FIG. 2. This clearly shows that the rotational axis 18 of the head 16 is eccentrically positioned in relation to the head 16. The head is, furthermore, positioned in a recess 19 in the shoe 1, which is intended to minimise the exposed portion of the joint 14. The locking pin 15 is provided with a cam 20, positioned on the end opposite the head 16, which retains the clamp 8. This cam 20 is solidly attached to the locking pin 15. The locking pin 15 functions primarily as a prestress bolt, designed to guarantee a reliable and relatively strong coupling of the beam-shaped elements.

FIG. 3b shows the cross-section of the joint 14, corresponding with FIG. 2, in the opened position. In the opened position, the head 16 is rotated around the axis 18 in contrast to the position of the head 16 shown in FIG. 3a. Through the eccentric rotation, the (effective) length of the locking pin 15 is increased, reducing the prestress between the shoe 1 and the clamp 8. In the opened position shown, the centrally located portions of the shoe 1 and the clamp 8 are positioned at a distance from one another. In this position, it is possible to remove (clamped) beam-shaped elements from the joint 14 and/or insert beam-shaped elements into the receptors 3, 10 of the shoe 1 and the clamp 8. In this way, a secure pre-assembly of the beam-shaped elements can be achieved, augmented by the distance restriction between the shoe 1 and the clamp established by the locking pin 15. After positioning the ends of the beam-shaped elements in the various receptors 3, 10, the head 16 of the locking pin 15 can once again be rotated, reducing the effective length of the locking pin 15, which results in a relatively solid and stable interconnection of the beam-shaped elements.

FIG. 4 shows a perspective view of another preferred embodiment of a joint 19 according to the invention in an operational arrangement. The joint 19 is qua construction virtually identical to the joint 14 shown in FIG. 2. However, in the joint 19 shown in FIG. 4, the shoe 20 and the clamp 21 are connected together by a locking pin 22, which is provided with an eccentric, rotatable head 23 that has a socket for a retaining pin (not shown). The retaining cap 22 is also provided with a socket (not visible), close to the head 23, for accepting a portion of the locking pin. This provision allows the joint 19 to be locked in the shown (closed) position by the locking pin, preventing the unintentional opening of the joint 19. The head 23 is, furthermore, releasably connected with a handle 25 to facilitate the rotation of the head 23.

FIG. 5 shows a perspective view of a joint 29 as shown in FIG. 4, that is ready for use. In the position shown, the handle 25 is detached from the head 23 and the locking pin 26 is positioned in the socket 24. This allows the clamped position of the beams (not shown) in the joint 19 to be consolidated and prevents, or at least inhibits, the (unintentional) change of position of the joint 19. The locking pin 26 is, additionally, connected to an attachment element 27 for connection of the joint 19 to an external object, such as, for example, a wall, a floor, an adjacent joint, a textile product, et cetera.

FIG. 6 shows a perspective view of another clamp 28 used in a device according to the invention. The clamp 28 is virtually identical to the clamp 8 shown in FIG. 1b. The clamp 28 is provided with, however, a passage 29 for a prestress bolt 30, such that the passage 29 is of a shape through which the flange 31 that is part of the prestress bolt 30 can be inserted. In the position shown, the flange 31 rests on the recess 32 in the clamp 28 and can only be removed from the clamp 28 after the prestress bolt 30 (and the flange 31) has (have) been rotated at right angle. The flange 31 is provided with a socket 33 for an attachment element (not shown) designed to attach the device to an external object.

It should be clear that the invention is not limited to the embodiments shown and described here, but that innumerable variations are possible within the framework of the attached claims, which will be obvious to a person skilled in this field.

1-12. (canceled)

13. A device for the interconnection of box-profile elements, comprising:
an at least substantially rigid first connection element provided with multiple first receptors for parts of multiple box-profile elements,
an at least substantially rigid second connection element adapted for cooperation with the first connection element, said second connection element being provided with multiple second receptors, corresponding to the first receptors, for parts of multiple box-profile elements, and
securing means coupled with the first connection element and the second connection element to secure the mutual connection of the first connection element and the second connection element, the securing means comprising at least one locking pin that is, at least partially enclosed by both connection elements, said locking pin being adapted for engagement on a side of the first connection element opposite to the second connection element and on a side of the second connection element opposite to the first connection element,
wherein
at least a portion of an inner side of the first receptors and of an inner side of the second receptors is at least partially profiled, wherein the profiled part of the receptors is adapted for cooperation with a counter-profile making part of the box-profile elements.

14. The device according to claim 13, wherein the effective length of the locking pin is adjustable.

15. The device according to claim 14, wherein the locking pin is provided with at least one eccentrically rotatable element.

16. The device according to claim 15, wherein the eccentrically rotatable element is provided with a handle.

17. The device according to claim 16, wherein the handle is releasably coupled with the eccentrically rotatable element.

18. The device according to claim 13, wherein the locking pin is provided with at least one cam.

19. The device according to claim 13, wherein the locking pin is releasably coupled to at least one connection element.

20. The device according to claim 13, wherein at least one connection element is provided with coupling means for coupling of the device to an external object.

21. The device according to claim 20, wherein the coupling means are releasably connected to the associated connection element.

22. An assembly of a device according to claim 13, and multiple box-profile elements, wherein the box-profile elements are clamped into the receptors of the device.

23. The assembly according to claim 22, wherein the box-profile elements are located at least substantially in a single plane.

24. A method for the interconnection of box-profile elements, comprising the steps of:
a) positioning of the ends of multiple box-profile elements in first and corresponding second receptors, at least a portion of the first receptors and second receptors being profiled at least partially, and
b) clamping of the box-profile elements into a device having rigid first and second connection elements, by shortening the effective length of a locking pin to achieve a prestress between the first connection element and the second connection element.
